(19) United States
(12) Patent Application Publication
(10) Pub. No.: US 2006/0280553 A1
(43) Pub. Date: Dec. 14, 2006

(54) Shaft coupler

(76) Inventor: Paul G. Anthony, Bakersfield, CA (US)

Correspondence Address: MARK D MILLER;KIMBLE, MACMICHAEL & UPTON, 5260 NORTH PALM AVENUE, SUITE 221, FRESNO, CA, 93704, US

(21) Appl. No.: 11/449,453

(22) Filed: Jun. 7, 2006

Related U.S. Application Data
(60) Provisional application No. 60/688,889, filed on Jun. 8, 2005.

(51) Int. Cl. F16B 21/02

(52) U.S. Cl. 403/348

(57) ABSTRACT

The present invention is a shaft coupler having two complementary bodies that may be joined together to form a coupling. Each body is designed to be fixedly attached to the end of a shaft and has one or more curved flanges that mate to corresponding flanges of another coupler body. The two coupler bodies are engaged together and rotated so that the surfaces of the two corresponding flanges are flush. This forms a void next to the mated flanges of the coupler bodies. One or more locking blocks are then inserted into the void to prevent the coupled bodies from untwisting, thereby securing the couplers in place and the shafts together. The locking block is attached to an interior segment of shaft by a fastener and the sides of the locking block come in flush contact with the sides of the coupler bodies and flanges thereof when attached. The coupler serves to rigidly fix the ends of the shafts together, end to end, to further the purposes of the user. The couplers are fixedly attached due to the mating of all the faces of the flanges of one coupler to the corresponding faces of the flanges of the other coupler body. The coupler is resistant to movement of the shafts with respect to each other in any direction including rotationally.

This application claims the benefit of U.S. Provisional Patent Application No. 60/688,889 filed on Jun. 8, 2005, which is incorporated herein by this reference.

### BACKGROUND OF THE INVENTION

1. Field of the Invention

The present invention relates to couplers, and more particularly to a unique non-threaded coupler for use in the secure connection of shafts in a linear orientation.

2. Description of the Prior Art

Cylindrical shafts, shafts, hollow tubes and the like (shafts) are commonly used in a multitude of mechanical devices. Shafts are used for many purposes in mechanical devices. For example, shafts can be used as structural supports, conduits for other parts of the device, a moving component, or a combination thereof. In addition, hollow shafts can supply pressurized gases or liquids from one location to another. In this context, a shaft can be any object of any size, shape, or function. It is often necessary to securely connect two shafts together to securely fix and prevent movement, of the shafts with respect to each other. Numerous couplers are known in the art that fasten two shafts together.

Existing couplers primarily rely on threaded connectors to connect two shafts together. The threaded connection of a coupler can either be straight or tapered. If tapered, the coupler usually has a torque shoulder to further rigidly connect the shafts together. Straight threaded connections also are used. Most straight threaded connectors employ a hex collar inserted in the coupler perpendicular to the axis of the shafts to prevent rotation and backout. While these couplers secure two shafts together, a substantial amount of time is taken to screw the couplers in place. This can be difficult if the shaft is of a large size or bulky. Another problem with conventional threaded connectors, is that threads can become worn, especially if cross threaded, making proper insertion and securing difficult.

Other couplers have methods of connecting that do not involve threading the joints of the shafts together. An example is shown in U.S. Pat. No. 535,278. This patent discloses a coupling with extensions that join together with slight rotation of the coupler. The coupler is then locked together by the use of one or more slidably mounted pins. One dilemma with this device is that the slidably mounted locking bolt makes the size and length of the coupler greater, and possibly difficult to use if in a confined space. In addition, the mechanism for securing the locking pin is likely not reliable enough for various operations as the laterally mounted pin is only held in place by the pressure of the bolt pushing against it.

Another alternative coupling device is shown in U.S. Pat. No. 1,818,261. This device locks by a slight amount of rotation of the coupling bodies. The device is then locked into place by securing a sleeve element over the coupling bodies. While the device secures the shafts together, it has disadvantages such as the inability to allow a passageway through the shaft due to the bulk of the coupling. In addition, the bolt securing the sleeve element of the coupler comes in direct contact with the force of the couplers, and therefore may fatigue or lessen over time.

U.S. Pat. No. 5,118,303 discloses a hermaphroditic coupler. The coupler does not have male and female ends, thereby eliminating the need for multiple different components. The device of the invention locks in place by rotating the latch arms of the coupler into an indent to prevent further movement. While this locking method secures electrical cables together to further prevent a disconnection, the means for locking of this device are not rigid enough to withstand forces upon a shaft used in a structural context. Further, a seal and o-ring is disclosed to create an environmental seal. While a seal is used on the device disclosed in this patent, it is not capable of keeping pressure within a passageway within the shaft or other body to which the coupler is connected.

Because of inherent disadvantages of the prior art, it is desirable to find a coupler that is capable of securely connecting two shafts together with a non-threaded connection that can be easily and quickly be coupled and uncoupled and capable of withstanding significant amounts of force or torque.

### SUMMARY OF THE INVENTION

The present invention is a shaft coupler having two complementary bodies that may be joined together to form a coupling. Each body is designed to be fixedly attached to the end of a shaft. Each coupler body has one or more curved flanges that mate to corresponding flanges of the other coupler body. The two coupler bodies are engaged together and rotated so that the end surfaces of the two corresponding flanges come in flush contact with each other. This forms a void next to the mated flanges of the coupler bodies. One or more locking blocks are then inserted into the void to prevent the coupler bodies from uncoupling and becoming unsecured. A locking block is attached to an interior segment of the coupler body by a fastener such that the sides of the locking block come in flush contact with the sides of the coupler bodies when the block is attached. The coupler bodies are fixedly attached due to the flush mating of all the faces of the flanges of one coupler body to the complementary faces of the flanges of the other coupler body. The engaged coupler bodies are resistant to movement with respect to each other in any direction, including rotationally. The engaged coupler bodies therefore serve to rigidly fix the ends of the shafts together, end to end, to further the purposes of the user.

The coupler of the present invention can connect any two segments of shafts together. A shaft can be any object of any size, shape, material or function as long as the object has an elongate end. As such, a shaft as defined herein covers rigid metallic cylinders, but also encompasses generally cylindrical objects made of many different materials, including flexible hosing and the like. Additionally, a shaft can be either hollow or solid in nature. In the drilling industry, such couplers are commonly used to secure shafts that are a portion of a drill bit, transmitter housing, back reamer, drill pipe, or other similar drilling tool.

The present invention is a coupler that can be used to quickly and efficiently connect two shafts together in a lengthwise fashion. The coupler is easily assembled. The coupler consists of two coupler bodies, a locking block, and a fastener for the locking block.

The base of each coupler body is cylindrical in shape and designed to be permanently affixed to the end of a shaft. Preferably, the coupler bodies are welded to the shaft, but the coupler bodies can be attached to the shaft in any manner commonly known in the art, such as by the use of fasteners, adhesives, epoxy, etc. The coupler body can be attached by its base to the end of a shaft. Alternatively, the shaft can extend into the coupler body a distance when it is attached. Further, a coupler body may itself be integrated as part of the shaft. The size of the base of the coupler body and the shaft can vary. The base of the coupler body can be of various sizes to allow for different sizes of shafts which are not necessarily cylindrical. In addition, the flanges of the coupler bodies which are discussed below, need not be proportional in size allowing for the connection of shafts of different diameters, if desired. If this is the case, the size of the portion of one of the coupler bodies which extends past the flanges of the coupler body (described as the interior cylinder below), may have to be of a different size in diameter compared to the shaft to allow for a proper connection.

In one embodiment, one of the coupler bodies has an interior cylinder which is a cylindrically hollow section that connects over the shaft. The interior cylinder can be of various diameters to fit on the end of a given shaft, allowing shafts of various diameters to be secured together. The coupler body also has a base which is a larger cylindrical section that the flanges connect to that extends a distance down the interior cylinder to ensure a proper and secure connection to the interior cylinder, and to prevent the possibility of the base of the coupler from becoming disengaged from the interior cylinder through the application of force or torque.

The interior cylinder of this first coupler body extends a distance beyond the flanges of the first coupler body. This allows the interior cylinder of the first coupler body to be inserted into the second coupler body when the coupler bodies are engaged. In this embodiment, the second coupler body is complementary to the first coupler body, but has no interior cylinder, as the interior cylinder of the first coupler body is inserted into the second coupler body. While the first and second coupler bodies are complimentary, the size and length of the base of each coupler body can vary. In an alternative embodiment, the second coupler body has an interior cylinder that may or may not abut, surround, or engage the cylinder of the first body. In this embodiment, the interior cylinder of the second coupler body does not extend beyond the base of the second coupler body. The second interior cylinder should create a flush mating surface against the first interior cylinder when the coupler bodies are properly engaged. In a yet another embodiment the interior cylinder of the first coupler body is a section of the shaft which passes through and beyond the base of the first coupler body.

In several embodiments, each coupler body has one or more identically shaped flanges located thereon. In one embodiment, each coupler body has two complementary shaped flanges at one end. Each flange extends from the base in the general shape of an inverted “L” where the surface within each flange corresponds to a complementary surface of an inverted “L” shaped flange of the other coupling body. The shape of the flanges can very greatly, but it is essential that each flange has a lateral projection extending a distance away from a horizontal projection (i.e. a first projection extending in the same direction as the end of the shaft and a second projection extending laterally therefrom). The flanges of the present invention are made to withstand significant amounts of stress and force to ensure the coupler will not pull apart once the coupler bodies are engaged under such force. With regard to drilling operations, the coupler should be capable of withstanding more stress than the drill pipe which it serves to connect such that the drill pipe will fail before the coupler does.

Each coupler body has a space around the L-shaped flange for receiving the flange of the corresponding coupler body. When assembled, the flanges come into contact so that the surfaces are flush with each other. This is accomplished by inserting the coupler bodies together by moving the ends of the shafts towards each other until the flanges of each coupler body fit into the space provided in the opposite coupler body. The coupler bodies and shafts are then rotated until the curved extensions of the L-shaped flanges come in flush contact with each other. The L-shaped flanges can be oriented in either direction so long as they compliment each other. The direction of rotation to lock the coupling in place is dependant on the orientation of the L-shaped brackets. This rotation causes the lateral extensions of the flanges to slide into the complementary opening in the other coupler body. In one embodiment, the brackets can be oriented in such away that any rotational force normally applied to the shafts is in the same direction which locks the coupler bodies in place. This further prevents any chance of disengagement based on an application of torque applied to the shafts and coupled connection.

Once the L-shaped flanges of each coupler body are inserted into the slots on the complementary coupler body and rotated into place, there are one or more voids left between the flanges of the coupling bodies exposing a section of the interior cylinder of the first coupler body. One or more locking blocks are inserted in the void by means of a fastener that attaches to the interior cylinder or to the edge of one of the “L” shaped flanges. In one embodiment, the fastener used is a hex bolt. Alternatively, the fastener can be of any commonly known in the art such as a bolt, screw, pin, clamp, etc. In a further embodiment the fastener can secure the locking block in the void by securing the locking block to the either the flange or body of either coupler bodies. In an additional embodiment, the locking block can be secured without a fastener by use of an adhesive or glue. Alternatively, the fastener can also be secured in place by the use of snap-fit connectors on the locking block and complementary mating surface on either coupler body or the interior cylinder to prevent the rotation of the flanges. The locking block is of a shape that fills the void and makes flush contact with the edges of the coupler bodies. In one embodiment, the locking block is of a generally rectangular shape. However, any suitable shape that fills the void may be used. After the locking block is affixed, it prevents any rotational movement of the coupler bodies with respect to each other. The coupler bodies cannot be detached from each other without the removal of the locking block and are fixed from rotating with respect to each other. In an alternative embodiment, the locking block can be removeably attached to either or both of the coupler bodies rather than the interior cylinder of the first coupler body.

The coupler bodies can vary in size and diameter based on the application. In addition, the material of which the coupler is constructed can be changed based on the needs of the user as long as the material is sufficiently rigid. Further, the coupler bodies, when engaged and secured in place with locking blocks create a cylinder of uniform diameter. By creating a coupler assembly that is of a uniform diameter, it is less prone to catch on other objects or cause an obstruction due to a component of the hinge extending laterally from shafts. This is of a larger concern when the shafts and shaft coupler assembly rotates, causing the lateral extension to rotate around the axis of the shafts.

In an additional embodiment of the invention, the shafts which are connected by the coupler can be hollow. Through the use of a seal, the passage through the hollow shafts can be connected by a hollow passage on the interior cylinder of the first and/or second coupler body to make a continuously sealed hollow passageway extending through the engaged coupler bodies. In one embodiment, this seal is in the form of an annular ring. A pressurized seal is created by inserting one or more seals in one or more annular indentations on the exterior of the interior cylinder of the first coupler body. This seal is then covered by the base of the second coupler body creating a pressurized seal to the now continuous hollow passageway. In a further embodiment, the hollow passageway and annular ring are on the interior of the second coupler body. A seal is created in the same manner describe above, by the insertion of the interior cylinder body into the second coupler body.

In a further embodiment, the coupling bodies are identical in shape. In this embodiment the first coupler body does not have an interior cylinder, or alternatively, both the first and second coupler bodies have interior cylinders of the same length. The length of the interior cylinders in this embodiment is not greater than half the distance of the coupler assembly to prevent the interior cylinders from obstructing the coupler bodies from engaging to each other. The use of identical coupler bodies allows for the user to secure the coupler bodies to the end of any shaft body without fear of being unable connect two shafts together due to the use of two non-complementary coupler bodies as can occur with male/female type couplers. In a preferred embodiment, these cylinders meet flush when the coupler bodies are engaged. An o-ring may so be placed between the cylinders to seal the opening.

It is therefore an object of the present invention to provide a shaft coupler which quickly and rigidly connects two shafts end to end.

A further object of the present invention is to provide a coupler where the coupler bodies secure to each other without using a threaded connection.

A further object of the present invention is to provide a coupler where the coupler bodies attach to the end of shafts and create a seal so that the interior cylinder is airtight.

### BRIEF DESCRIPTION OF THE DRAWINGS

FIG. 1 is an exploded view of the shaft coupler of the present invention.

FIG. 2 is a side perspective view of the shaft coupler assembly of the present invention in an un-attached position illustrating the use of the shaft coupler to rigidly connect shafts together lengthwise.

FIG. 3 is a side perspective view of the shaft coupler assembly of the present invention in an attached position illustrating the use of the shaft coupler to rigidly connect shafts together lengthwise.

### DETAILED DESCRIPTION

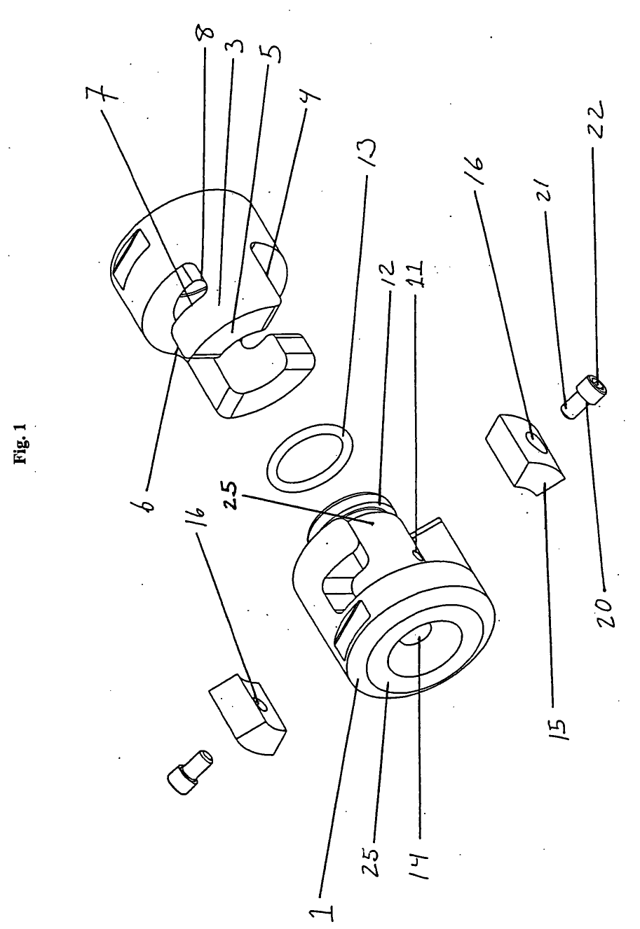

Referring to the drawings wherein like reference characters designate like or corresponding parts throughout the several views, and referring particularly to FIG. 1, it is seen that the coupler invention includes two coupler bodies 1. The coupler bodies 1 are each attached to the ends of separate shafts 10. An interior cylinder 25 extends past the end of the first coupler body. Each coupler body 1 has one or more flanges 3 that are in the general shape of an inverted “L.” Each flange has a rear vertical face 4, upper lateral face 5, extended vertical face 6, lower lateral face 7, and indented vertical face 8. The faces of the flange contact and mate with the complementary faces of the flange of the other coupling body.

To attach two shafts by use of the coupler, the user inserts the flanges of the coupler bodies into the void next to the one or more flanges of the other coupler body. The coupler bodies are then rotated until the extended vertical face 6 of each flange of the coupler bodies mate with the indented vertical face 8 of the complementary flange 3. When the coupler bodies are in this position, the rear vertical face 4 of the coupler bodies are not in contact with any surface, allowing the coupler to be rotated in the other direction and removed from contact with each other. To prevent this, and secure the coupler bodies in place, one or more locking blocks 15 are affixed to the interior cylinder 25 to prevent the rotational movement of the coupler bodies 1 and shafts attached thereto. The locking blocks 15 may be attached to the interior cylinder 25 by way of fasteners 20. The fastener has an attachment section 21 and a head section 22. The attachment section 21 passes through a passage 16 in the locking block and an opening 11 in the interior cylinder 25. The attachment section 21 of the fastener 20 can attach to the opening 11 in the interior cylinder by any methods commonly known in the art. The head section 22 of the fastener 20 has an opening allowing for the insertion of a tool to apply rotational pressure to the fastener. In one embodiment, the fastener 20 is a screw or hex bolt having threads on the attachment section 21 which mate to threads in the opening 11 on the interior cylinder 25.

When in place, the sidewalls of the locking block 15 come into flush contact with the rear vertical faces 4 of the flanges 3 and upper edge of the base of the coupler bodies. The mating of each respective surface of the coupler bodies and locking block rigidly secures the shafts 10 together to prevent movement of the shafts with respect to each other.

While the locking blocks lock the coupler bodies together, thereby rigidly attaching the shafts, the coupler bodies can be easily uncoupled by the removal of the fasteners 20 and locking block 15. Once the locking block is removed, the coupler bodies can be rotated and then pulled apart, thereby releasing the shafts from each other.

The locking block can be secured against the walls of the flanges of the coupler bodies in various ways. The block can be secured using a fastener connected to the inner cylinder, or to the flanges or base portion of either coupler body. In addition, the block can be removeably secured by the use of a snap-fit connection with any of the surfaces in which it comes in contact with, such as one of the flanges of the coupler bodies. Further, the block can be secured by the use of adhesives or epoxies.

In another preferred embodiment, the interior cylinder can be hollow thereby allowing the passage of material through the shaft. If the shafts are hollow, the coupler can serve to make a seal at the connection of the two shafts to allow pressurized fluid or gas to pass through the shafts. The inner cylinder 25 of one of the coupler bodies has an indented annular recess 12 over which an annular ring 13 can be placed. When the shafts are coupled together, the annular ring creates an airtight seal between the interior cylinder 25 and a coupler body 1 thereby keeping liquid or gasses in the passageway 14 of the interior cylinder from being exposed to the external environment, and vice versa. It is to be noted in this embodiment that the opening 11 in the internal cylinder should not extend into the passageway 14 of the interior cylinder to ensure that the passageway remains pressurized. In an alternative embodiment, the seal in the form of an indented annular recess and annular ring is on the interior of one of the coupler bodies, not the interior cylinder.

The coupler bodies 1 can be attached to the shafts 10 by any means known in the art. If the coupler bodies are of the same size then they are interchangeable, allowing any given set of shafts to be firmly attached to each other by use of the coupler. Standard size coupler bodies can be made that correspond. to the varying size shafts commonly found in the art.

The coupler serves to rigidly fix the shafts together due to the flush mating of all the faces of the flanges of one coupler body to the corresponding faces of the flanges of the other coupler body. The coupler is resistant to movement of the shafts with respect to each other in any direction, including rotationally.

The present invention can work on a variety of different sized shafts. In one embodiment, the coupler can be made to fit on shafts varying between two to six inches in outside diameter. Other embodiments of the invention can be used with shafts of any outside diameter.

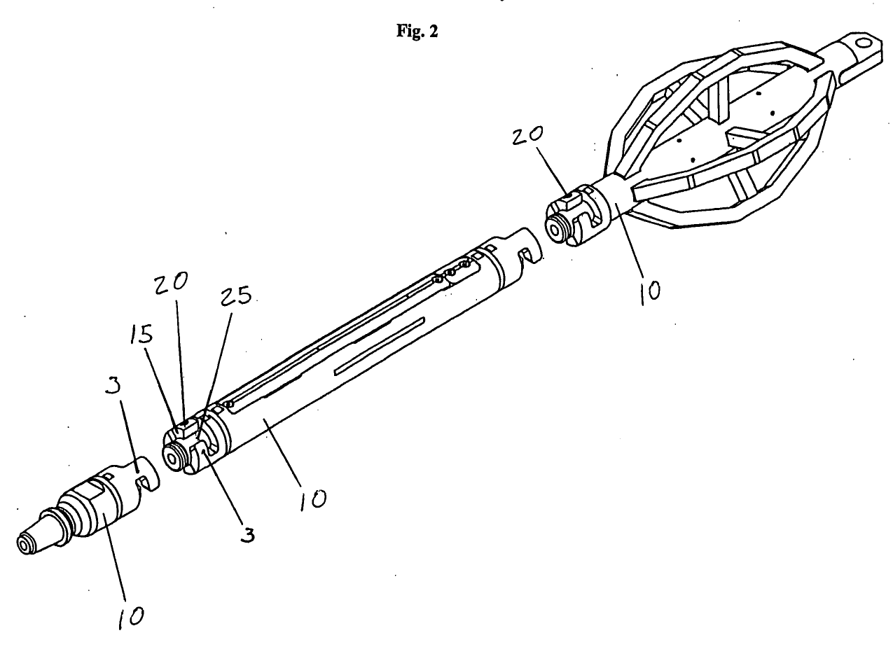

FIG. 2 is a depiction of two sets of coupler bodies along a shaft-type device in an unattached position. This illustrates how the coupler bodies can be used to connect different cylindrical type devices together. Moreover, the locking blocks are attached to the interior cylinder by the fastener, and must be removed before the coupler bodies can be connected. In addition, the figure shows that the shafts connected by the pair of coupler bodies are hollow and a sealed passageway remains after the shafts are connected.

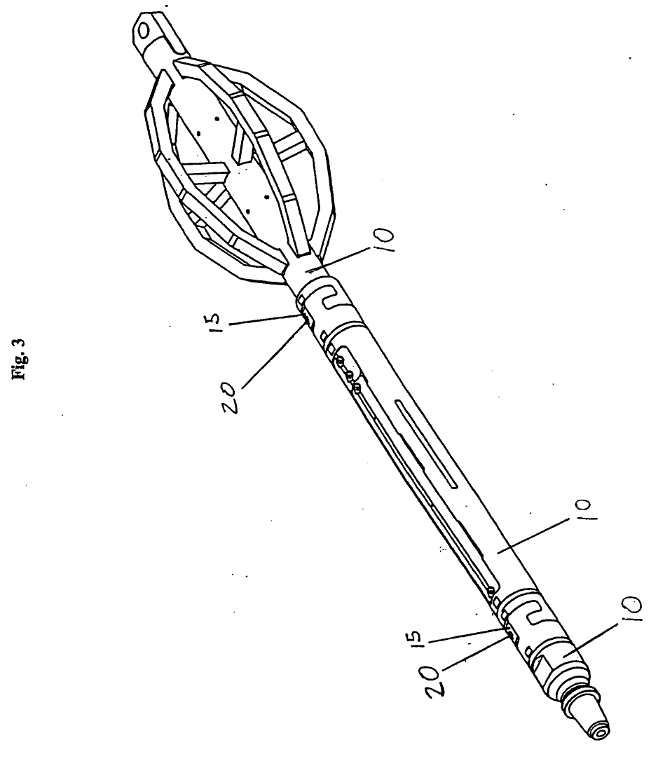

FIG. 3 is a depiction of two pairs of coupler bodies attaching three shaft-like devices. The shafts in the pictures are cylindrical at the end of the shaft where the coupler bodies attach, but may be of any given shape after that point. The coupler bodies rigidly connect the shafts lengthwise and prevent any movement of the shafts with respect to each other.

It is to be understood that variations and modifications of the present invention may be made without departing from the scope thereof. It is also to be understood that the present invention is not to be limited by the specific embodiments disclosed herein, but only in accordance with the appended claims when read in light of the foregoing specification.

What is claimed is:

1. A coupler comprising
a first generally cylindrical body comprising a proximal end having an opening therein for receiving a first shaft and a distal end having at least one L-shaped flange located thereon, said flange surrounding a central cylindrical section,
a second generally cylindrical body comprising a proximal end having an opening therein for receiving a second shaft and a distal end having at least one complementary L-shaped flange located thereon, and
a locking piece;
wherein the engagement of the complementary flanges of each of said first and second bodies creates a void for insertion of said locking piece to prevent rotational disengagement of the bodies.

2. The coupler of claim 1 wherein the locking piece attaches to the central cylindrical section.

3. The coupler of claim 1 wherein the locking piece attaches to one of the flanges.

4. The coupler of claim 1 wherein the locking piece attaches to a slot on at least one of said flanges.

5. The coupler of claim 4 wherein the locking piece snap fits into said slot.

6. The coupler of claim 1 wherein the central cylindrical section is hollow.

7. The coupler of claim 6 wherein an annular indentation is provided on said central cylindrical section and an annular ring is placed in the indentation creating a seal when the first and second bodies are engaged together.

8. The coupler of claim 1 wherein a fastener secures the locking piece to the central cylindrical section.

9. The coupler of claim 8 wherein the fastener is a hex bolt or screw.

10. A shaft coupler comprising a first coupler body having a first cylindrical base that is attached to the outside of an interior cylinder and has at least one flange with longitudinal projections that mate with at least one complementary flange of a second coupler body, and a locking block that fits in a void between the mated flanges of the coupler bodies for securing the coupler bodies and preventing movement of the coupler bodies with respect to each other.

11. The coupler of claim 10 wherein the engagement of the complementary flanges create a flush connection.

12. The coupler of claim 10 wherein the central cylindrical section is hollow.

13. The coupler of claim 12 wherein an annular indentation is provided on the outer surface of the central cylindrical section.

14. The coupler of claim 13 wherein an annular ring is provided in the annular indentation creating a seal with the second coupler body when the first and second bodies are engaged together.

15. The coupler of claim 14 wherein the seal allows for the passage of fluids or gasses through the shafts connected by the coupler.

16. The coupler of claim 10 wherein a fastener secures the locking block to the central cylindrical section.

17. The coupler of claim 16 wherein the fastener is a hex bolt or screw.

18. A coupler comprising
a first generally cylindrical body comprising a proximal end having an opening therein for receiving a shaft and a distal end having at least one L-shaped flange located thereon, said flange surrounding a central cylindrical section,
a second generally cylindrical body comprising a proximal end having an opening therein for receiving a shaft and a distal end having at least one complementary L-shaped flange located thereon, and
a locking piece;
wherein the engagement of the complementary flanges of each of said first and second bodies creates a void into which said locking piece is inserted to prevent rotational disengagement of the bodies;
wherein the engagement of the complementary flanges creates a flush connection;
wherein the locking piece attaches to one of the group consisting of: the central cylindrical section, a flange, a slot on at least one of said flanges, and combinations thereof;
wherein a fastener secures the locking piece and the fastener is a hex bolt, a screw or a snap fit connection;
wherein the central cylindrical section is hollow, an annular indentation is provided on said central cylindrical section and an annular ring is placed in the indentation creating a seal when the first and second bodies are engaged together.

19. A method for connecting two shafts end to end comprising the steps of
a. securing a first coupler body to an end of a first shaft;
b. securing a second coupler body to an end of a second shaft;
c. placing the shafts end to end with the couplers facing each other;
d. inserting at least one flange of the first coupler body into at least one opening adjacent to a complementary flange of the second coupler body;
e. rotating the coupler bodies until the complementary surfaces of the flanges are in flush contact with each other; and
f. securing a locking piece between then the mated flanges of the coupler bodies.

20. The method for connecting two shafts end to end further comprising the additional step of inserting a fastener to hold the locking block in place.

21. A coupler comprising
a first coupling means comprising a proximal end having receiving means for a first shaft and a distal end having at least one flange means located thereon, said flange means surrounding a central cylindrical section,
a second coupling means comprising a proximal end having receiving means for a second shaft and a distal end having at least one flange means located thereon, and
a locking means;
wherein the engagement of the flange means of each of said first and second coupling means creates a void into which said locking means may be inserted to prevent rotational disengagement of the coupling means.
